(19) United States
(12) Patent Application Publication
(10) Pub. No.: US 2014/0033884 A1
(43) Pub. Date: Feb. 6, 2014

(54) Method and system for producing void fill material

(71) Applicant: Russell Tether, Carrollton, TX (US)

(72) Inventor: Russell Tether, Carrollton, TX (US)

(21) Appl. No.: 13/507,887

(22) Filed: Aug. 3, 2012

(51) Int. Cl. B26D 7/06

(52) U.S. Cl. 83/24; 83/98

(57) ABSTRACT

Corropak is usually produced from surplus corrugated board using the system shown in the present application, which includes sets of cutting and friction rollers. Guide rollers, static guides, and tables are shown in the present invention, as well as various drive mechanism configurations, to assist with the processing of the cardboard or containerboard material. Several different roller configurations are also shown.

### TECHNICAL FIELD OF INVENTION

The present invention relates to recycling corrugated/flat materials to produce void fill material for use in packaging. In particular, the present void fill material is made by recycling corrugated cardboard and the like and is designed to interlock with adjacent void-fill material.

### BACKGROUND OF THE INVENTION

Today's environmental emphasis is changing the way many companies and consumers do business. It is no longer acceptable to just provide quality products at the lowest cost. Today's users are requiring companies to consider the long term effects of products and their manufacture. From aerosols to diapers to packaging, products must not be a detriment to the environment.

There are many void fill materials on the market today. These products are made from expanded polystyrene, shredded wood, corn starch, shredded paper, and popcorn. For example, shredded wood, known as “excelsior,” is used a great deal in overseas shipping. It provides reasonable protection, but is expensive and is not as effective as other fill material for small and delicate products. It also requires hand packing, since it will not “flow” through any void fill machinery. Hand packing has been known to cause a condition known as Carpal Tunnel Syndrome and, therefore, the increased incidence of worker's compensation.

Shredded paper was once in common use. However, the paper settles during shipment and, therefore, does not provide the cushioning most users require during the entire shipping term. Also, shredded paper does not flow and is also very messy. If the source of the paper is newspaper, the ink comes off on the product and the packer's hands. The paper cannot be easily handled. Reaching into the container and packing it by hand is required, also potentially leading to Carpal Tunnel Syndrome. Shredded paper also attracts paper mites.

“Ecopak®” is a product on the market made of 95% corn starch with other chemicals making up the other 5%. This product costs about $0.75 per cubic foot with a target price of $0.55 per cubic foot. This is double the cost of current void fills. In humid or wet conditions, the product will disintegrate, leaving a residue on the product and degrading its ability to cushion. It is biodegradable, but not recycled.

Popcorn showed promise as a void fill material, but has now been banned by the F.D.A. for us in packing because people might eat it. Popcorn also attracts insects because it is a food source containing natural oils. These oils can also rub off on the packaged product.

Polystyrene “peanuts” are a common form of void fill packing material. They come in many forms: “S”, “J”, “W”, “C” and a concave disk shape. All “peanuts” have a petrochemical base. Most use Chlorofluorocarbons (CFC's) in production. CFC's are considered to contribute to the deterioration of the ozone layer of the earth's atmosphere. Polystyrene is also a danger to the environment because it does not decompose. Sold to converters as a bead, the polystyrene is heated and expanded to the desired shape. It offers protection to the products packaged.

Polystyrene “peanuts” tend to settle, allowing the product to shift to an unprotected position within the box. The letter-shaped peanuts offer more cushioning than do the disk-shaped ones. The disk flattens with little pressure. Once flattened, the disk-shaped peanut offers only the cushioning of its thickness (approximately 1/32 inch). Polystyrene costs range from $0.25 to $0.35 per cubic foot. One advantage is that it can be stored in hoppers mounted to the inside roof of a building and over the packing stations. The peanuts are blown into hoppers using a blower and a long tube. The packers then simply open a scissors-like valve to allow the peanuts to flow into the box, thereby surrounding the product.

Last, “Quadrapak®” is a product on the market that is made of recycled corrugated cardboard. The material is shredded and then fan folded into strips. Its promise is limited because it does not flow through existing equipment, weighs the same as shredded paper, and costs as much as polystyrene void fill.

“Corropak®” has also been a corrugated cardboard fill material created for use in the “void fill” market. There is a need to produce the Corropak void fill material in a more efficient manner, and to eliminate problems in manufacturing the product from recycled materials.

A need exists for a method for producing a packing material that is effective and cost efficient. This packing material must be environmentally friendly. Namely, the material should be biodegradable, recyclable, recycled and reusable. Moreover, the packing material should be easily produced on-site with relatively inexpensive source material.

### SUMMARY OF THE INVENTION

The present void fill system, also known as Corropak, replaces all other void fill materials. Corropak accomplishes this by shaping ordinary scrap cardboard, chipboard, corrugated board, or other suitable materials, collectively called either “corrugated materials” or “corrugated board.” Corropak interlocks with surrounding Corropak void fill material. The material is typically shaped like the uprights in football or a block “Y” design. Thus, the void fill material is designed to effectively interlock with adjacent pieces of void fill material for increased cushioning.

Unlike polystyrene void fill, Corropak is environmentally safe. Corropak is produced from corrugated material, a blend of paper and starch. Corropak recycles discarded corrugated material into a new product that can be reused multiple times. When the void fill is worn out, it is collected and recycled into new paper products or containerboard. Moreover, Corropak does not carry the static charge that styrofoam peanuts carry, which is important for packaging of computers or electronics.

Corropak is usually produced from surplus corrugated board using the system shown in the present application, which includes sets of cutting and friction rollers. Guide rollers, static guides, and tables are shown in the present invention, as well as various drive mechanism configurations, to assist with the processing of the cardboard or containerboard material. Several different roller configurations are also shown.

Corropak should help reduce the number of trees necessary to make corrugated board by increasing the demand for used corrugated boxes. American container manufacturers are building more efficient recycling plants. However, only 50% of corrugated board is recaptured and only 21% is recycled. Corropak will make more companies and individuals aware of saving boxes. Also, many more companies and retail outlets will have containers specifically for surplus and scrap corrugated material. It is hoped Corropak will help increase the amount of recycled board to over 90% of production.

### BRIEF DESCRIPTION OF THE DRAWINGS

FIG. 1 is a perspective view of a 4-roller embodiment of the equipment used to produce the present void fill material;

FIG. 2 is a perspective view of a 4-roller with two center-mounted guide rollers embodiment of the equipment used to produce the present void fill material;

FIG. 3 is a perspective view of a 4-roller with three pair of spatially mounted guide rollers embodiment of the equipment used to produce the present void fill material;

FIG. 4 is a perspective view of a 4-roller two static center-mounted guides embodiment of the equipment used to produce the present void fill material;

FIG. 5 is a perspective view of a 4-roller with three pair of static spatially-mounted guides embodiment of the equipment used to produce the present void fill material;

FIG. 6 is a perspective view of a 4-roller with two square static center-mounted guides embodiment of the equipment used to produce the present void fill material;

FIG. 7 is a perspective view of a 4-roller with three pair of square static spatially mounted guides embodiment of the equipment used to produce the present void fill material;

FIG. 8A is a perspective view of a one motor four transverse gear box embodiment of the driving method used to control the 4-roller embodiment;

FIG. 8B is a perspective view of a four motor embodiment of the driving method used to control the 4-roller embodiment;

FIG. 8C is a perspective view of a two motor embodiment of the driving method used to control the 4-roller embodiment;

FIG. 9 is a perspective view of a 3-roller embodiment of the equipment used to produce the present void fill material;

FIG. 10 is a perspective view of a 3-roller center strip no-cut zone embodiment of the equipment used to produce the present void fill material;

FIG. 11 is a perspective view of a 3-roller center strip no-cut zone embodiment of the equipment with two spatially-mounted guide rollers used to produce the present void fill material;

FIG. 12A is a perspective view of one motor three transverse gear box embodiment of the driving mechanism used to control the 3-roller embodiment;

FIG. 12B is a perspective view of a three motor embodiment of the driving mechanism used to control the 3-roller embodiment;

FIG. 12C is a perspective view of a one motor embodiment of the driving mechanism used to control the 3-roller embodiment;

FIG. 13A is a perspective view of cylindrical embodiment of a roller;

FIG. 13B is a perspective view of cylindrical with inclined side edges embodiment of a roller;

FIG. 13C is a perspective view of a cylindrical with a no-cut center strip embodiment of a roller;

FIG. 13D is a perspective view of a cylindrical with no-cut center strip and inclined side edges embodiment of a roller;

FIG. 14 is a perspective view of an assembly framework assembly supporting a 4-roller embodiment with a driving mechanism embodiment;

FIG. 15 is a detailed view of an mounting mechanism for affixing or mounting the roller to assembly framework;

FIG. 16A is a detailed cross section view of an embodiment of a roller as shown in FIG. 17A showing air flow holes for ejection of cut pieces;

FIG. 16B is a detailed section view of an embodiment of a roller as shown in FIG. 17B showing air flow holes for ejection of cut pieces;

FIG. 17A is a detailed view of an embodiment of a cutting roller showing dental/saw tooth horizontal cutting blades;

FIG. 17B is a detailed view of an embodiment of a cutting roller showing liner vertical cutting blades;

FIG. 18A is an illustrative view of the post-cut void fill material;

FIG. 18B is an illustrative view demonstrating an appropriate overcut of the post-cut void fill material;

FIG. 19A-B are illustrative views demonstrating an appropriate undercut of the post-cut void fill material; and

FIG. 20 shows a cutting guide table with tension spring mounts.

### DETAILED DESCRIPTION

The present void fill system, also known as Corropak, replaces all other knows void fill materials and is produced in a more efficient manner using the present invention. Corropak accomplishes this by shaping ordinary scrap cardboard, chipboard, corrugated board, or other suitable materials, collectively called either “corrugated materials” or “corrugated board” into a novel and nonobvious configuration. This useful configuration allows the Corropak to interlock with surrounding Corropak void fill material. The material is typically shaped like the uprights in football or a block “Y” design. Thus, the void fill material is designed to effectively interlock with adjacent pieces of void fill material for increased cushioning.

Unlike polystyrene void fill, Corropak is environmentally safe. Corropak is produced from corrugated material, a blend of paper and starch. Corropak recycles discarded corrugated material into a new product that can be reused multiple times. When the void fill is worn out, it is collected and made into new containerboard. Moreover, Corropak does not carry the static charge that styrofoam peanuts carry.

Corropak is usually produced from surplus corrugated board using the system shown in the present application, which includes sets of cutting and friction rollers. Guide rollers and static guides are shown as well as various drive mechanism configurations. Several different roller configurations are also shown. Wall thickness can be singlewall or doublewall. The board fluting can be A, B, C, E, or Asian board.

The design of Corropak void fill promotes the interlocking of the Corropak pieces to reduce settling of the package contents and to increase cushioning properties. Each “finger” of the void fill can be scored to more easily bend. This design absorbs more space per piece and provides additional impact protection. Further, because Corropak can be made from fluted corrugated board, it provides a minimum of cushioning at least as thick as the corrugated board. This provides added protection to the products packed in it. Corropak will also help increase the amount of chipboard that is recycled for the same reasons.

Corropak should help reduce the number of trees necessary to make corrugated board by increasing the demand for used corrugated boxes. American container manufacturers are building more efficient recycling plants. However, only 50% of corrugated board is recaptured and only 21% is recycled. Corropak will make more companies and individuals aware of saving boxes. Also, many more companies and retail outlets will have containers specifically for surplus and scrap corrugated material. It is hoped Corropak will help increase the amount of recycled board to over 90% of production.

The present invention shows the use of guide rollers, static guides and table guides, which assist with supporting the cutting material and flattening it out prior to cutting. The guide rollers can also be configured to speed up the feeding of the cutting material prior to or during the cutting process. These innovations are significant improvements over the prior art; and improve the quality of the finished void material and reduce negative impacts on the cutting and support rollers. All these improvements result in a cost savings for production.

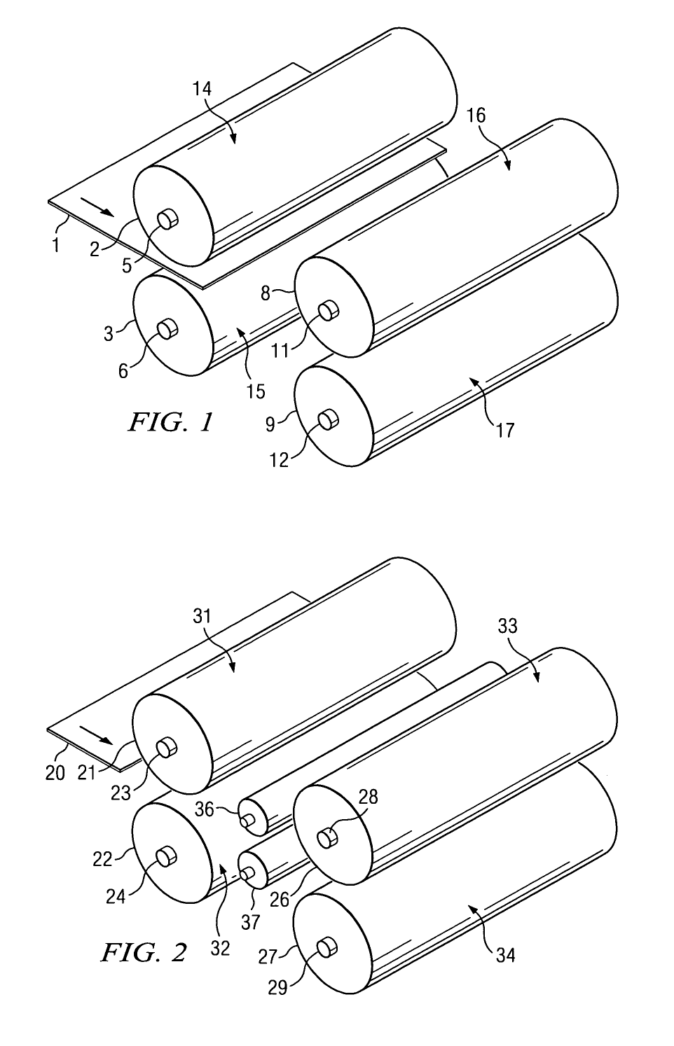

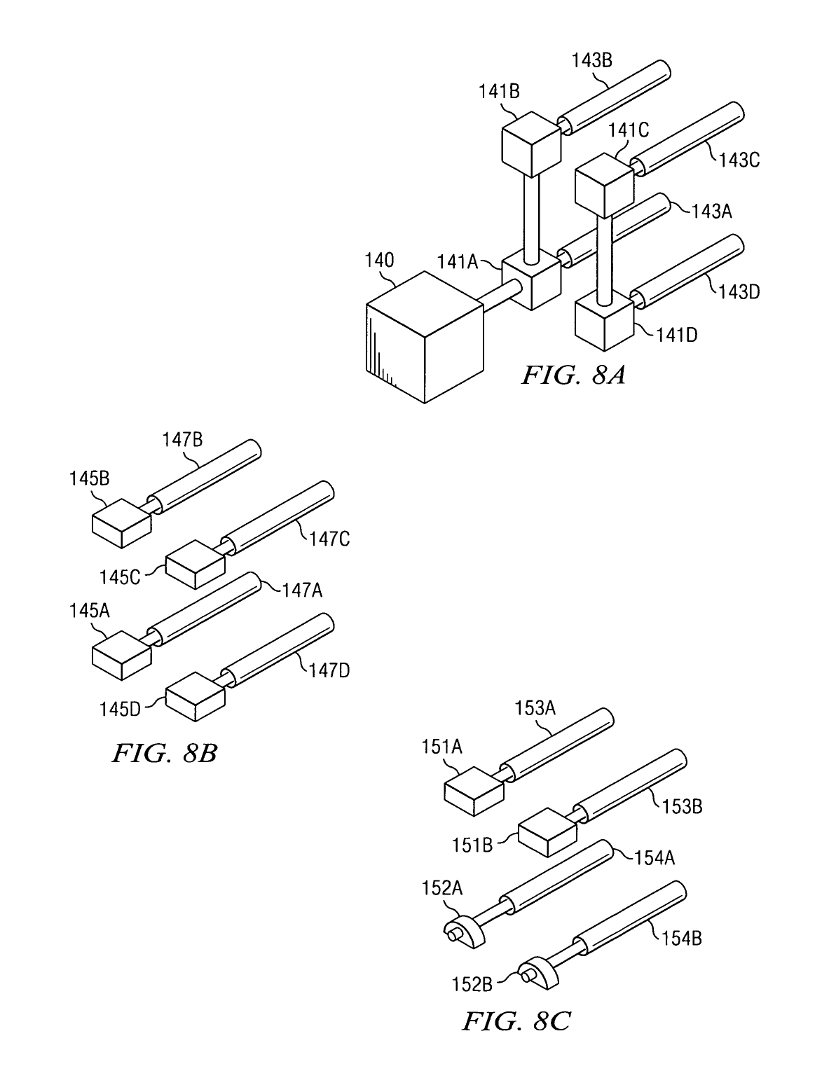

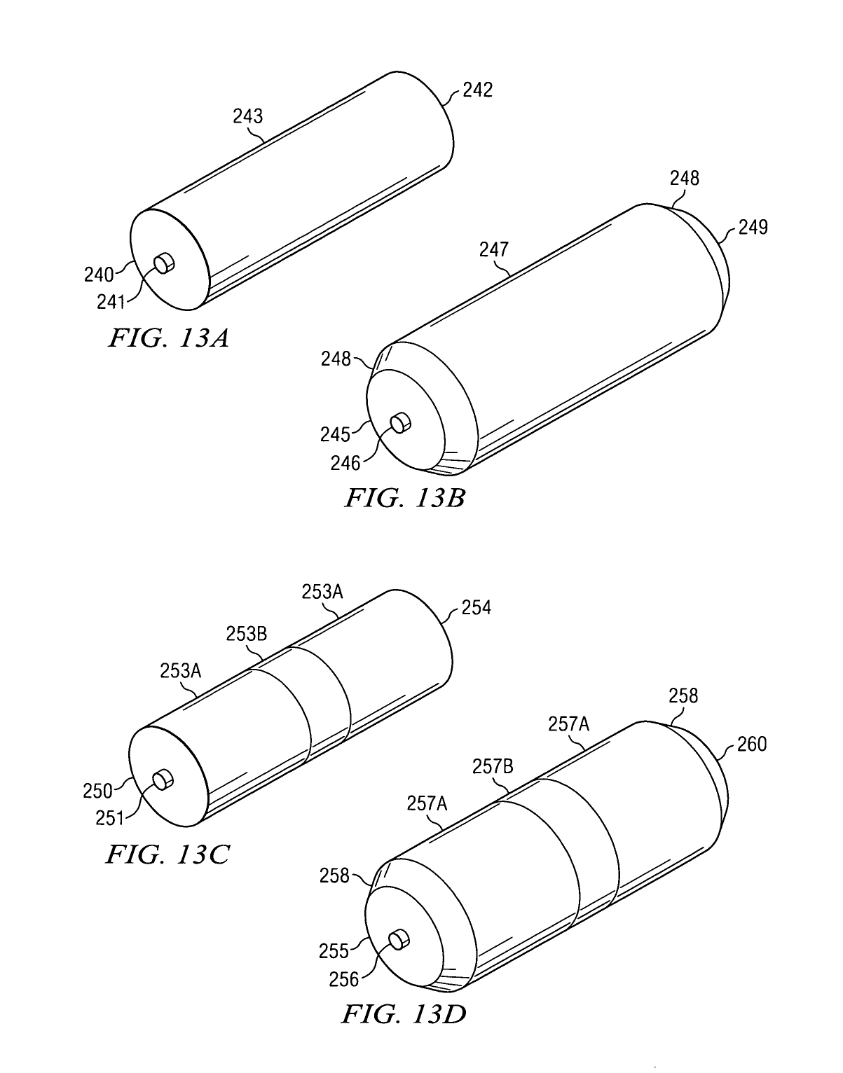

Referring to FIG. 1, a rotary die cutting apparatus is shown with cutting rollers 2 and 8 and friction rollers 3 and 9. Cutting material 1 is first fed into cutting and friction roller pair 2 and 3 and then continuously fed into cutting and friction roller pair 8 and 9 where it is cut into the packing void material of a desired shape. Rollers 2, 3, 8, and 9 are attached to a structural framework and may be rotated by conventional power means well known in the art or free spinning. These rollers may use any of the roller configurations shown in FIGS. 13A-D, and any of the drive assemblies shown in FIGS. 8A-C.

Cutting roller 2 rotates on axle 5 while friction roller 3 rotates on axle 6. Cutting roller 8 rotates on axle 11 while friction roller 9 rotates on axle 12. The cutting surface 14 of cutting roller 2 is shown in FIG. 17A. The cutting surface 16 of cutting roller 8 is shown in FIG. 17B. The surfaces 15 and 17 of the friction rollers 3 and 9 are usually smooth and compressible to allow slight penetration by the cutting blades while still maintaining a supporting position for the workpiece.

Alternate embodiments allow the cutting rollers 2 and 8 and friction rollers 3 and 9 be interchangeable as long as cutting rollers remain in series with each other and not opposite each other, for example, not cutting the material simultaneously.

Referring to FIG. 2, a rotary die cutting apparatus is shown with two center-mounted guide rollers and cutting rollers 21 and 26 and friction rollers 22 and 27. Cutting material 20 is first fed into cutting and friction rollers 21 and 22 and then continuously fed into cutting and friction rollers 26 and 27 where it is cut into the packing void material of a desired shape. Guides 36 and 37 may be placed after rollers 21 and 22 to help keep level and guide cutting material 20 into rollers 26 and 27. Rollers 21, 22, 26, and 27 are attached to a structural framework and may be rotated by conventional power means well known in the art or free spinning. These rollers may use any of the roller configurations shown in FIGS. 13A-D, and any of the drive assemblies shown in FIGS. 8A-C. Guides 36 and 37 are also attached to a structural framework and may sit stationary or rotate free spinning about their axles.

Cutting roller 21 rotates on axle 23 while friction roller 22 rotates on axle 24. Cutting roller 26 rotates on axle 28 while friction roller 27 rotates on axle 29. The cutting surface 31 of cutting roller 21 is shown in FIG. 17A. The cutting surface 33 of cutting roller 26 is shown in FIG. 17B. The surfaces 32 and 34 of the friction rollers 22 and 27 are usually smooth and compressible to allow slight penetration by the cutting blades while still maintaining a supporting position for the workpiece.

Alternate embodiments allow the cutting rollers 21 and 26 and friction rollers 22 and 27 be interchangeable as long as cutting rollers remain in series with each other and not opposite each other, for example, not cutting the material simultaneously.

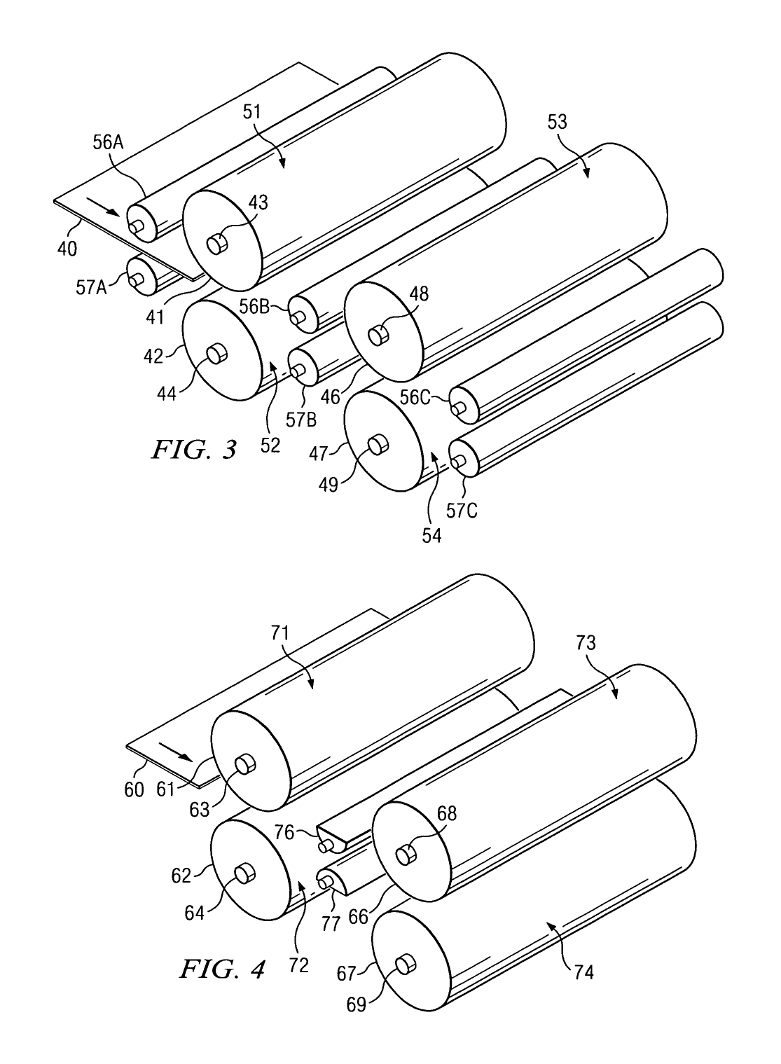

Referring to FIG. 3, a rotary die cutting apparatus is shown with three pair of spatially-mounted guide rollers and cutting rollers 41 and 46 and friction rollers 42 and 47. These rollers may use any of the roller configurations shown in FIGS. 13A-D, and any of the drive assemblies shown in FIGS. 8A-C. Cutting material 40 is first fed into cutting and friction rollers 41 and 42 and then continuously fed into cutting and friction rollers 46 and 47 where it is cut into the packing void material of a desired shape. Guides 56A-C and 57A-C may be placed so that guides 56A and 57A are positioned before rollers 41 and 42, guides 56B and 57B are positioned after rollers 41 and 42 and before rollers 46 and 47, and guides 56C and 57C are positioned after rollers 46 and 47 to help keep level and guide cutting material 40.

Rollers 41, 42, 46, and 47 are attached to a structural framework and may be rotated by conventional power means well known in the art or free spinning. Guides 56A-C and 57A-C are also attached to a structural framework and may sit stationary or rotate free spinning about their axles. Cutting roller 41 rotates on axle 43 while friction roller 42 rotates on axle 44. Cutting roller 46 rotates on axle 48 while friction roller 47 rotates on axle 49. The cutting surface 51 of cutting roller 41 is shown in FIG. 17A. The cutting surface 53 of cutting roller 46 is shown in FIG. 17B. The surfaces 52 and 54 of the friction rollers 42 and 47 are usually smooth and compressible to allow slight penetration by the cutting blades while still maintaining a supporting position for the workpiece.

Alternate embodiments allow the cutting rollers 41 and 46 and friction rollers 42 and 47 be interchangeable as long as cutting rollers remain in series with each other and not opposite each other, for example, not cutting the material simultaneously.

Referring to FIG. 4, a rotary die cutting apparatus with two static center-mounted guides and is shown with cutting rollers 61 and 66 and friction rollers 62 and 67. Cutting material 60 is first fed into cutting and friction rollers 61 and 62 and then continuously fed into cutting and friction rollers 66 and 67 where it is cut into the packing void material of a desired shape. These rollers may use any of the roller configurations shown in FIGS. 13A-D, and any of the drive assemblies shown in FIGS. 8A-C. Guides 76 and 77 may be placed after rollers 61 and 62 to help keep level and guide cutting material 60 into rollers 66 and 67.

Rollers 61, 62, 66, and 67 are attached to a structural framework and may be rotated by conventional power means well known in the art or free spinning. Guides 76 and 77 are also attached to a structural framework and may sit stationary or rotate free spinning about their axles. Cutting roller 61 rotates on axle 63 while friction roller 62 rotates on axle 64. Cutting roller 66 rotates on axle 68 while friction roller 67 rotates on axle 69. The cutting surface 71 of cutting roller 61 is shown in FIG. 17A. The cutting surface 73 of cutting roller 66 is shown in FIG. 17B. The surfaces 72 and 74 of the friction rollers 62 and 67 are usually smooth and compressible to allow slight penetration by the cutting blades while still maintaining a supporting position for the workpiece.

Alternate embodiments allow the cutting rollers 61 and 66 and friction rollers 62 and 67 be interchangeable as long as cutting rollers remain in series with each other and not opposite each other, for example, not cutting the material simultaneously.

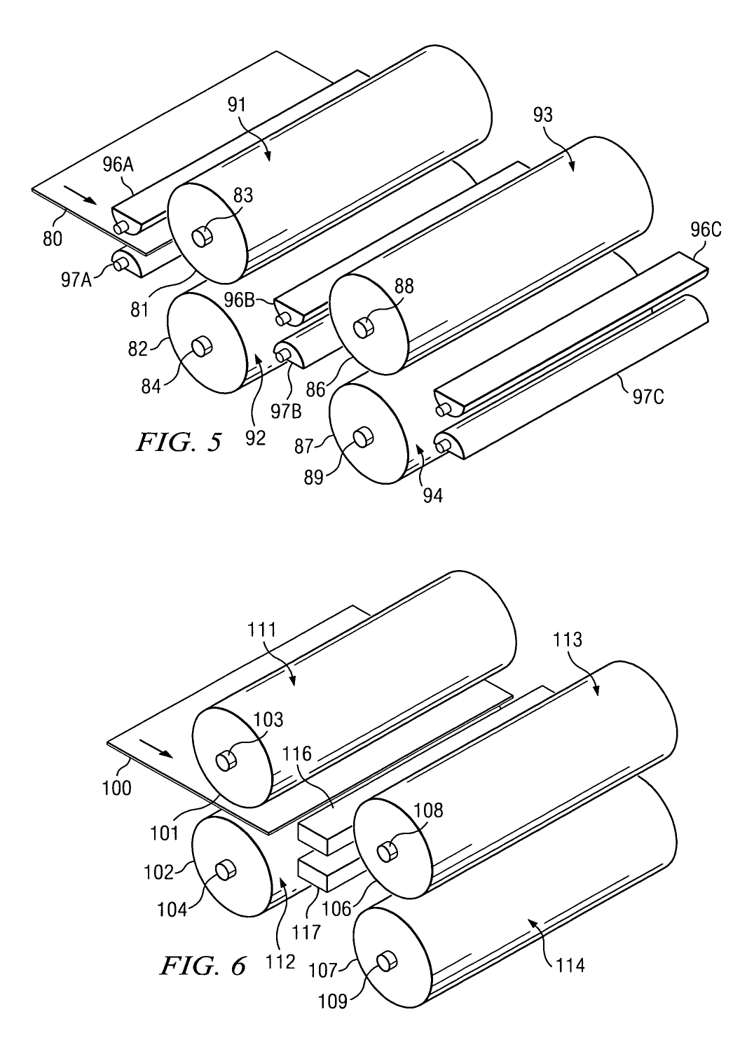

Referring to FIG. 5, a rotary die cutting apparatus is shown with three pair of static spatially-mounted guides and cutting rollers 81 and 86 and friction rollers 82 and 87. Cutting material 80 is first fed into cutting and friction rollers 81 and 82 and then continuously fed into cutting and friction rollers 86 and 87 where it is cut into the packing void material of a desired shape. These rollers may use any of the roller configurations shown in FIGS. 13A-D, and any of the drive assemblies shown in FIGS. 8A-C. Guides 96A-C and 97A-C may be placed so that guides 96A and 97A are positioned before rollers 81 and 82, guides 96B and 97B are positioned after rollers 81 and 82 and before rollers 86 and 87, and guides 96C and 97C are positioned after rollers 86 and 87 to help keep level and guide cutting material 80.

Rollers 81, 82, 86, and 87 are attached to a structural framework and may be rotated by conventional power means well known in the art or free spinning. Guides 96A-C and 97A-C are also attached to a structural framework and may sit stationary or rotate free spinning about their axles. Cutting roller 81 rotates on axle 83 while friction roller 82 rotates on axle 84. Cutting roller 86 rotates on axle 88 while friction roller 87 rotates on axle 89.

The cutting surface 91 of cutting roller 81 is shown in FIG. 17A. The cutting surface 93 of cutting roller 86 is shown in FIG. 17B. The surfaces 92 and 94 of the friction rollers 82 and 87 are usually smooth and compressible to allow slight penetration by the cutting blades while still maintaining a supporting position for the workpiece.

Alternate embodiments allow the cutting rollers 81 and 86 and friction rollers 82 and 87 be interchangeable as long as cutting rollers remain in series with each other and not opposite each other, for example, not cutting the material simultaneously.

Referring to FIG. 6, a rotary die cutting apparatus is shown with two square static center-mounted guides and cutting rollers 101 and 106 and friction rollers 102 and 107. Cutting material 100 is first fed into cutting and friction rollers 101 and 102 and then continuously fed into cutting and friction rollers 106 and 107 where it is cut into the packing void material of a desired shape. These rollers may use any of the roller configurations shown in FIGS. 13A-D, and any of the drive assemblies shown in FIGS. 8A-C. Guides 116 and 117 may be placed after rollers 101 and 102 to help keep level and guide cutting material 100 into rollers 106 and 107.

Rollers 101, 102, 106, and 107 are attached to a structural framework and may be rotated by conventional power means well known in the art or free spinning. Guides 116 and 117 are also attached to a structural framework and may sit stationary or rotate free spinning about their axles. Cutting roller 101 rotates on axle 103 while friction roller 102 rotates on axle 104. Cutting roller 106 rotates on axle 108 while friction roller 107 rotates on axle 109.

The cutting surface 111 of cutting roller 101 is shown in FIG. 17A. The cutting surface 113 of cutting roller 106 is shown in FIG. 17B. The surfaces 112 and 114 of the friction rollers 102 and 107 are usually smooth and compressible to allow slight penetration by the cutting blades while still maintaining a supporting position for the workpiece.

Alternate embodiments allow the cutting rollers 101 and 106 and friction rollers 102 and 107 be interchangeable as long as cutting rollers remain in series with each other and not opposite each other, for example, not cutting the material simultaneously.

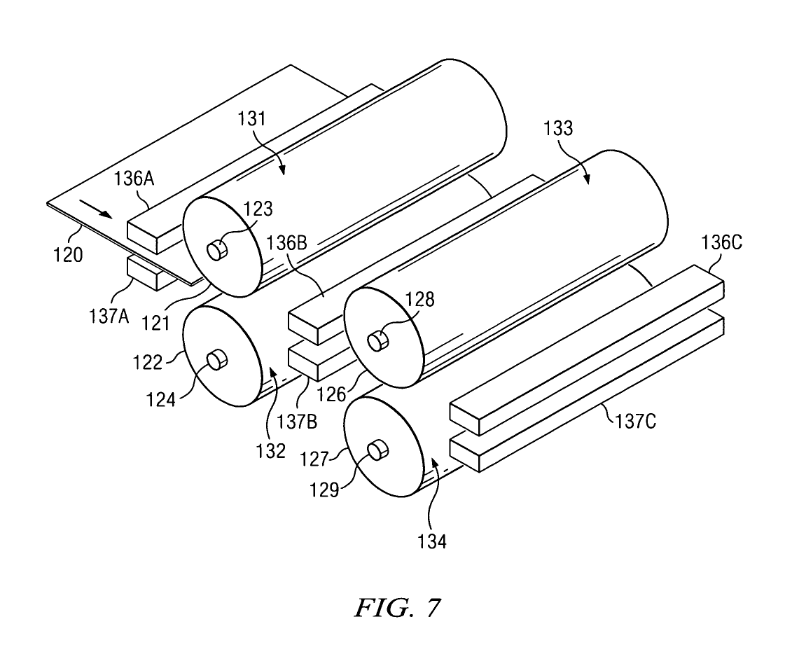

Referring to FIG. 7, a rotary die cutting apparatus is shown with three pair of square static spatially-mounted guides and cutting rollers 121 and 126 and friction rollers 122 and 127. Cutting material 120 is first fed into cutting and friction rollers 121 and 122 and then continuously fed into cutting and friction rollers 126 and 127 where it is cut into the packing void material of a desired shape. These rollers may use any of the roller configurations shown in FIGS. 13A-D, and any of the drive assemblies shown in FIGS. 8A-C. Guides 136A-C and 137A-C may be placed so that guides 136A and 137A are positioned before rollers 121 and 122, guides 136B and 137B are positioned after rollers 121 and 122 and before rollers 126 and 127, and guides 136C and 137C are positioned after rollers 126 and 127 to help keep level and guide cutting material 120.

Rollers 121, 122, 126, and 127 are attached to a structural framework and may be rotated by conventional power means well known in the art or free spinning. Guides 136A-C and 137A-C are also attached to a structural framework and may sit stationary or rotate free spinning about their axles. Cutting roller 121 rotates on axle 123 while friction roller 122 rotates on axle 124. Cutting roller 126 rotates on axle 128 while friction roller 127 rotates on axle 129.

The cutting surface 131 of cutting roller 121 is shown in FIG. 17A. The cutting surface 133 of cutting roller 126 is shown in FIG. 17B. The surfaces 132 and 134 of the friction rollers 122 and 127 are usually smooth and compressible to allow slight penetration by the cutting blades while still maintaining a supporting position for the workpiece.

Alternate embodiments allow the cutting rollers 121 and 126 and friction rollers 122 and 127 be interchangeable as long as cutting rollers remain in series with each other and not opposite each other, for example, not cutting the material simultaneously.

Referring to FIG. 8A, a one motor four transverse gear box embodiment of the driving method is illustrated in which a master driving mechanism 140 controls driving mechanisms 141A-D. Driving mechanisms 141A-D respectively control the rotation of roller axles 143A-D. Similar or different gear setups in each driving mechanism 141A-D may be used to determine rotational speed of roller axles 143A-D.

For example, roller axles 143 B and C are synonymous with axles 5 and 11 in FIG. 1, therefore driving mechanisms 141 B and C drive the rotation of rollers 2 and 8. Likewise, roller axles 143 A and D are synonymous with axles 6 and 12 in FIG. 1, therefore driving mechanisms 141 A and D drive the rotation of rollers 3 and 9.

Referring to FIG. 8B, a four motor embodiment of the driving method is illustrated in which driving mechanisms 145A-D each drive their respective roller axle (147A-D) individually. Driving mechanisms 145A-D respectively control the rotation of roller axles 147A-D.

For example, roller axles 147 B and C are synonymous with axles 5 and 11 in FIG. 1, therefore driving mechanisms 145 B and C drive the rotation of rollers 2 and 8. Likewise, roller axles 147 A and D are synonymous with axles 6 and 12 in FIG. 1, therefore driving mechanisms 145 A and D drive the rotation of rollers 3 and 9.

Referring to FIG. 8C, a two motor embodiment of the driving method is illustrated in which driving mechanisms 151A-B each drive their respective cutting roller axle (153A-B) individually. Mounts 152A-B provide a mounting area for friction roller axles 154A-B and may allow friction roller axles 154A-B to sit stationary or rotate freely.

For example, roller axles 153 A and B are synonymous with axles 5 and 11 in FIG. 1, therefore driving mechanisms 151 A and B drive the rotation of rollers 2 and 8. Likewise, roller axles 154 A and B are synonymous with axles 6 and 12 in FIG. 1, therefore mounts 152 A and B allow rollers 3 and 9 to remain stationary or freely rotate.

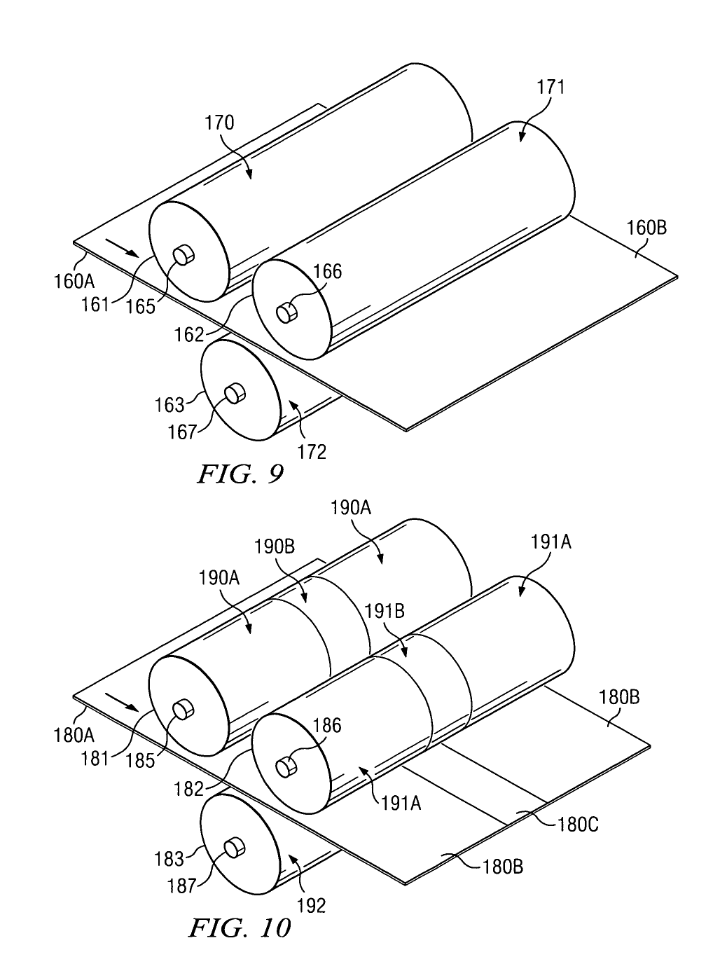

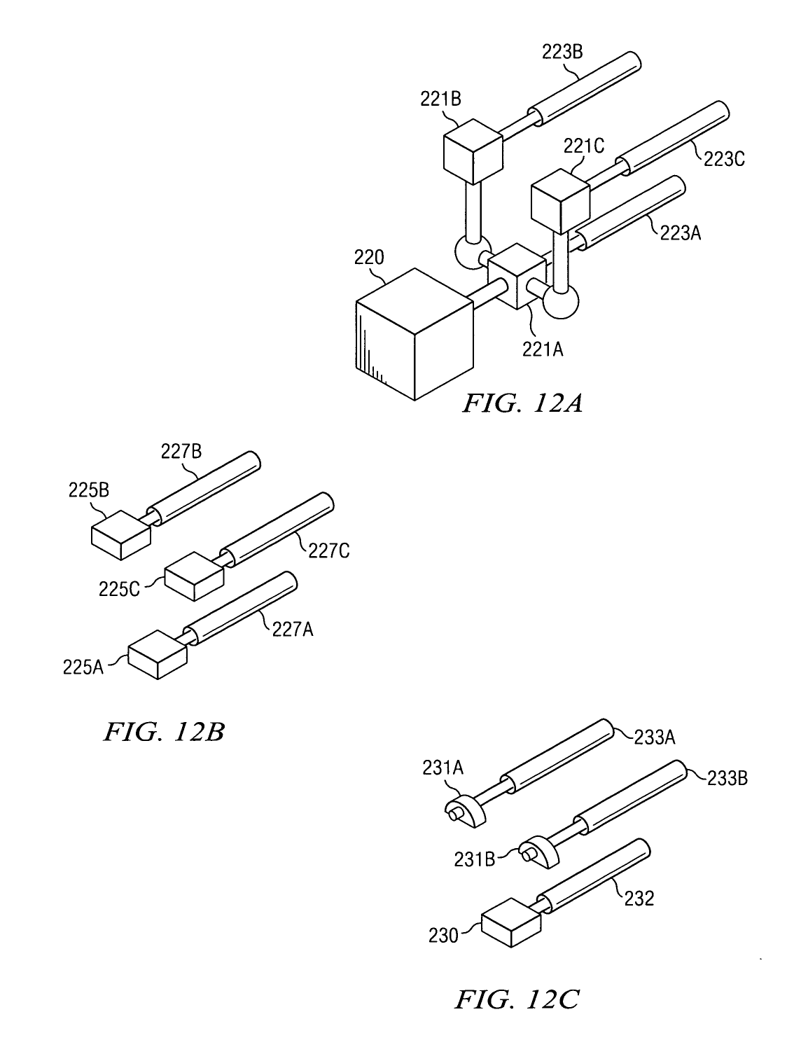

Referring to FIG. 9, a rotary die cutting apparatus is shown with cutting rollers 161 and 162 and friction roller 163. Pre-cut material 160A is first fed into cutting roller 161 and then continuously fed into friction roller 163 followed by cutting roller 162 where it leaves the apparatus as post-cut material 160B. Rollers 161, 162, and 163 are attached to a structural framework and may be rotated by conventional power means well known in the art or free rolling, where it is cut into the packing void material of a desired shape. Cutting roller 161 rotates on axle 165, cutting roller 162 rotates on axle 166, and friction roller 163 rotates on axle 167. These rollers may use any of the roller configurations shown in FIGS. 13A-D, and any of the drive assemblies shown in FIGS. 12A-12C.

The cutting surface 170 of cutting roller 161 is shown in FIG. 17A. The cutting surface 171 of cutting roller 162 is shown in FIG. 17B. The surface 172 of friction roller 163 is usually smooth and compressible to allow slight penetration by the cutting blades while still maintaining a supporting position for the workpiece.

Alternate embodiments allow the cutting rollers 161 and 162 and friction roller 163 be interchangeable as long as cutting rollers remain in series with each other and not opposite each other. An example alternate embodiment has cutting rollers 161 and 162 on the bottom portion of the assembly device and friction roller 163 on the upper portion of the assembly device.

Referring to FIG. 10, a rotary die cutting apparatus is shown with a center no-cut strip and cutting rollers 181 and 182 and friction roller 183. These rollers may use any of the roller configurations shown in FIGS. 13A-D, and any of the drive assemblies shown in FIGS. 12A-12C. Pre-cut material 180A is first fed into cutting roller 181 and then continuously fed into friction roller 183 followed by cutting roller 182 where it leaves the apparatus as post-cut material 180B and 180C where it is cut into the packing void material of a desired shape. Cutting roller 181 comprises a cutting portion 190A and a solid portion 190B. Cutting roller 182 comprises a cutting portion 191A and a solid portion 191B.

Post-cut material 180B is the result of pre-cut material 180A passing along cutting portions 190A and 191 A. Post-cut material 180C is material not cut in the process that passed along the solid portions 190B and 191B. Solid portions 190B and 191B provide more friction to push the material through the apparatus and aides in keeping the material from getting stuck inside the cutting grooves. Rollers 181, 182, and 183 are attached to a structural framework and may be rotated by conventional power means well known in the art or free rolling. Cutting roller 181 rotates on axle 185, cutting roller 182 rotates on axle 186, and friction roller 183 rotates on axle 187.

The cutting surface 190A of cutting roller 181 is shown in FIG. 17A. The cutting surface 191A of cutting roller 182 is shown in FIG. 17B. The surface 192 of friction roller 183 is usually smooth and compressible to allow slight penetration by the cutting blades while still maintaining a supporting position for the workpiece.

Alternate embodiments allow the cutting rollers 181 and 182 and friction roller 183 be interchangeable as long as cutting rollers remain in series with each other and not opposite each other. An example alternate embodiment has cutting rollers 181 and 182 on the bottom portion of the assembly device and friction roller 183 on the upper portion of the assembly device.

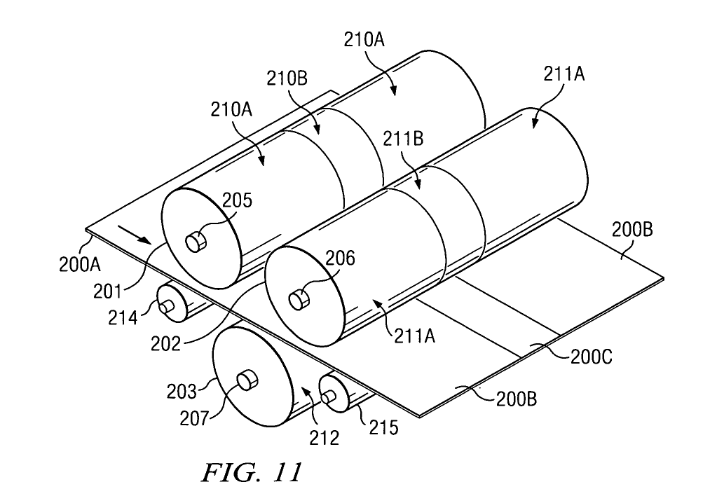

Referring to FIG. 11, a rotary die cutting apparatus is shown with a center no-cut strip and cutting rollers 201 and 202 and friction roller 203 and two spatially-mounted guide rollers 214 and 215. These rollers may use any of the roller configurations shown in FIGS. 13A-D, and any of the drive assemblies shown in FIGS. 12A-12C. Pre-cut material 200A is first fed into cutting roller 201 and then continuously fed into friction roller 203 followed by cutting roller 202 where it leaves the apparatus as post-cut material 200B and 200C where it is cut into the packing void material of a desired shape. Cutting roller 201 comprises a cutting portion 210A and a solid portion 210B. Cutting roller 202 comprises a cutting portion 211A and a solid portion 211B.

Post-cut material 200B is the result of pre-cut material 200A passing along cutting portions 210A and 211A. Post-cut material 200C is material not cut in the process that passed along the solid portions 210B and 211B. Solid portions 210B and 211B provide more friction to push the material through the apparatus and aides in keeping the material from getting stuck inside the cutting grooves. Guiding roller 214 may be placed before cutting roller 201 to help keep level and guide pre-cut material 200A into cutting roller 201. Guiding roller 215 may be placed after cutting roller 202 to help keep level and guide post-cut material 200B and 200C out of the cutting apparatus. Rollers 201, 202, and 203 are attached to a structural framework and may be rotated by conventional power means well known in the art or free rolling.

Guides 214 and 215 are also attached to a structural framework and may sit stationary or rotate free spinning about their axles. While only one embodiment of guides is shown, guides 214 and 215 may also share the appearance of guides shown in FIGS. 4-7. Cutting roller 201 rotates on axle 205, cutting roller 202 rotates on axle 206, and friction roller 203 rotates on axle 207. The cutting surface 210A of cutting roller 201 is shown in FIG. 17A. The cutting surface 211A of cutting roller 202 is shown in FIG. 17B. The surface 212 of friction roller 203 is usually smooth and compressible to allow slight penetration by the cutting blades while still maintaining a supporting position for the workpiece.

Alternate embodiments allow the cutting rollers 201 and 202 and friction roller 203 be interchangeable as long as cutting rollers remain in series with each other and not opposite each other. An example alternate embodiment has cutting rollers 201 and 202 on the bottom portion of the assembly device and friction roller 203 on the upper portion of the assembly device.

Referring to FIG. 12A, an embodiment of a one motor and four transverse gear box transmission driving method is illustrated in which a master driving mechanism 220 controls driving mechanisms 221A-C. Driving mechanisms 221A-C are transmission gearboxes that respectively rotate of roller axles 223A-C. Drive mechanism 220 is coupled to transmission gearbox 221A which drives axle 223A. Transmission gearbox 221A is also coupled to transmission gearboxes 221C and 221B to drive axles 223C and 223B, respectively. Similar or different gear setups in each driving mechanism 221A-C may be used to determine rotational speed of roller axles 223A-C.

For example in FIG. 12B, roller axles 225B, 225C and 225A are three motor assembly with axles 227B, 227C, and 227A being driven by motor drivers 225B, 225C, and 225A. Referring to FIG. 12B, an embodiment of the driving method is illustrated in which driving mechanisms 225A-C each drive their respective roller axle (227A-C) individually. Driving mechanisms 225A-C respectively control the rotation of roller axles 227A-C.

For example, roller axles 227 B and C are synonymous with axles 165 and 166 in FIG. 9, therefore driving mechanisms 225 B and C drive the rotation of rollers 161 and 162. Likewise, roller axle 227 A is synonymous with axle 167 in FIG. 9, therefore driving mechanism 225 A drives the rotation of rollers 163.

Referring to FIG. 12C, a single drive mechanism embodiment of the driving method is illustrated in which driving mechanism 230 drives friction roller axle 232 individually. Mounts 231A-B provide a mounting area for cutting roller axles 233A-B and may allow cutting roller axles 233A-B to sit stationary or rotate.

For example, roller axles 233 A and B are synonymous with axles 165 and 166 in FIG. 9, therefore driving mechanisms 231 A and B drive the rotation of rollers 161 and 162. Likewise, roller axle 232 is synonymous with axle 167 in FIG. 9, therefore driving mechanism 230 drives the rotation of rollers 163.Sgs

Alternatively, mounts 231 A and B may be driving mechanisms with driving mechanism 230 as a mount allowing the rollers in series to be driven and leave the roller opposite to remain stationary or free to rotate.

Referring to FIG. 13A, a roller 240 has a uniform cylindrical surface 243 between one end 340 and the opposite end 242. Uniform surface 243 may be a cutting surface or solid surface. Roller 240 rotates about axle 241.

Referring to FIG. 13B, a roller 245 has a uniform surface 243 with tapered include end surfaces 248 between first end and 245 and second end 249. Uniform surface 247 between the incline and portions may be a cutting surface or solid surface. Roller 245 rotates about axle 246.

Referring to FIG. 13C, a roller 250 has a surface with a first portion 253A and a second portion 253B. First portion 253A is a cutting surface. Second portion 253B may be a no-cutting surface strip or solid surface, which assists in the movement of the cutting material 1 across and through the rollers. The solid no-cutting surface makes contact with the cutting material to assist movement through the rollers assembly. Preferably first portion 253A is a cutting surface and second portion 253B is a solid portion. Roller 250 rotates about axle 251. The cylinder 250 has a first and second end 254.

Referring to FIG. 13D, a roller 255 has a surface with a first portion 257A and a second portion 257B. Roller 255 also has tapered surfaces 258 at each end. First portion 257A is a cutting surface. Second portion 257B may is a no-cut strip solid surface. Preferably first portion 257A is a cutting surface and second portion 257B is a solid portion. Roller 255 rotates about axle 256. The cylinder 255 has a first end 255 and a second end 260.

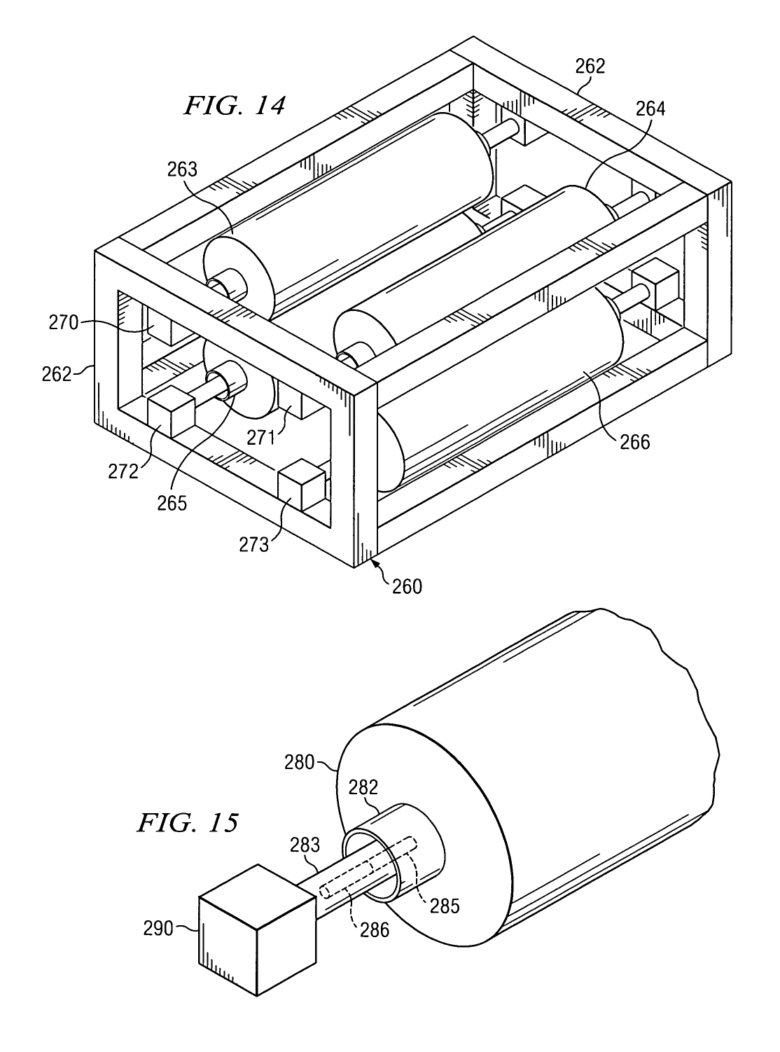

Referring to FIG. 14, a rack support assembly framework 260 is shown using a four roller embodiment with a four drive motor driving mechanism embodiment. Assembly framework 260 comprises a frame 262. Frame 262 provides areas where driving mechanisms 270, 271, 272, and 273 may be secured. Cutting rollers 263 and 264 are driven by driving mechanisms 270 and 271. Friction rollers 265 and 266 are driven by driving mechanisms 272 and 273. While a roller configuration similar to FIG. 1 is illustrated, any roller configuration shown in FIG. 2-7 or 9-11 can be used with the respective drive mechanism shown in FIG. 8A-8C or 12A-12C, with any different cylinder configuration shown in FIGS. 13A-D. While a driving mechanism configuration similar to FIG. 8B is illustrated, any driving mechanism configuration shown in 8A-D or 12A-C may be used.

Referring to FIG. 15, an attachment mechanism for affixing the roller to assembly framework is illustrated. Roller 280 has attachment member 282 secured to the roller axle. Attachment member 282 comprises a locking mechanism 285 that locks the cylinder into joint 286 on the axle 283 of the drive mechanism 290 assembly. Driving mechanism 290 has a complimentary attachment joint member 283 which comprises locking mechanism 286. Locking mechanisms 285 and 286 secure to each other when lock is engaged. When lock is disengaged, roller may be easily removed or put in place.

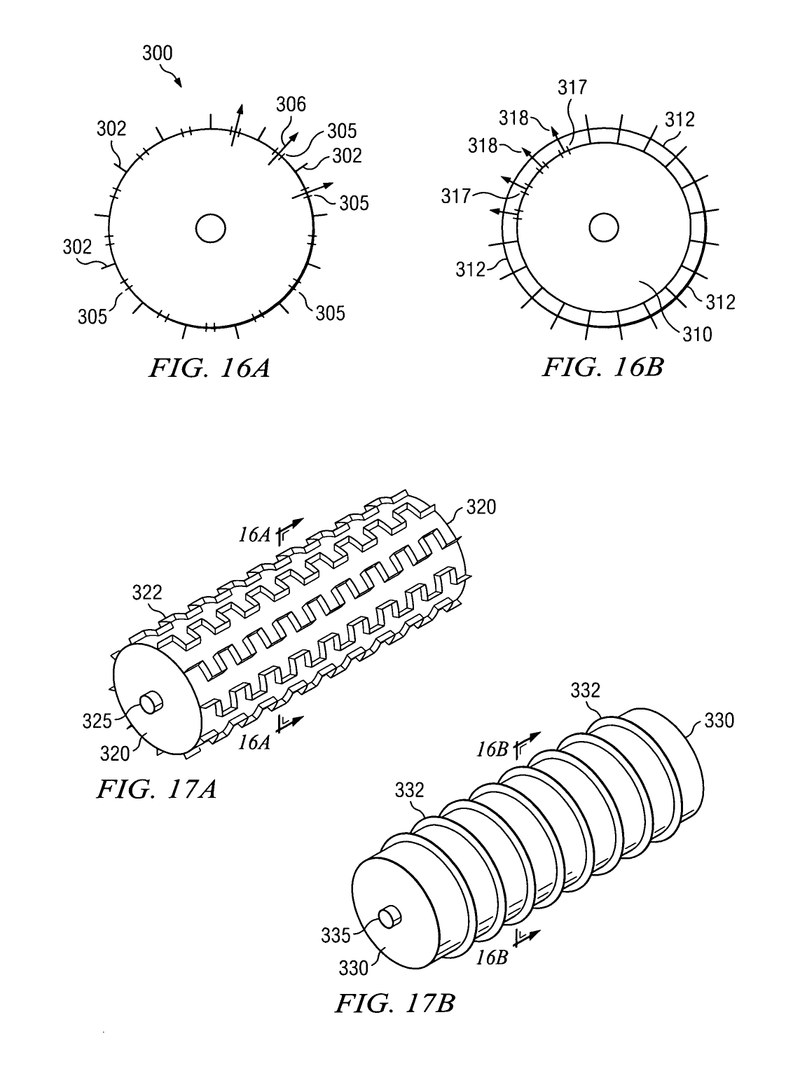

FIG. 16A is a cross-sectional view of cutting roller as illustrated in FIG. 17A. Cutting roller 300 defines various holes 305 along its outer surface. As illustrated, cutting roller 305 comprises cutting elements 302 (322 in FIG. 17A). Pressurized airflow 306 passes through holes 305 to assist in keeping cut material void fill from remaining stuck between cutting elements 302.

FIG. 16B is a cross-sectional view of cutting roller as illustrated in FIG. 17B. Cutting roller 310 may define various holes 317 along its surface. As illustrated, cutting roller 310 comprises cutting element 312 (332 in FIG. 17B). Air 318 passes through holes 317 to assist in keeping material from remaining stuck between cutting elements 312.

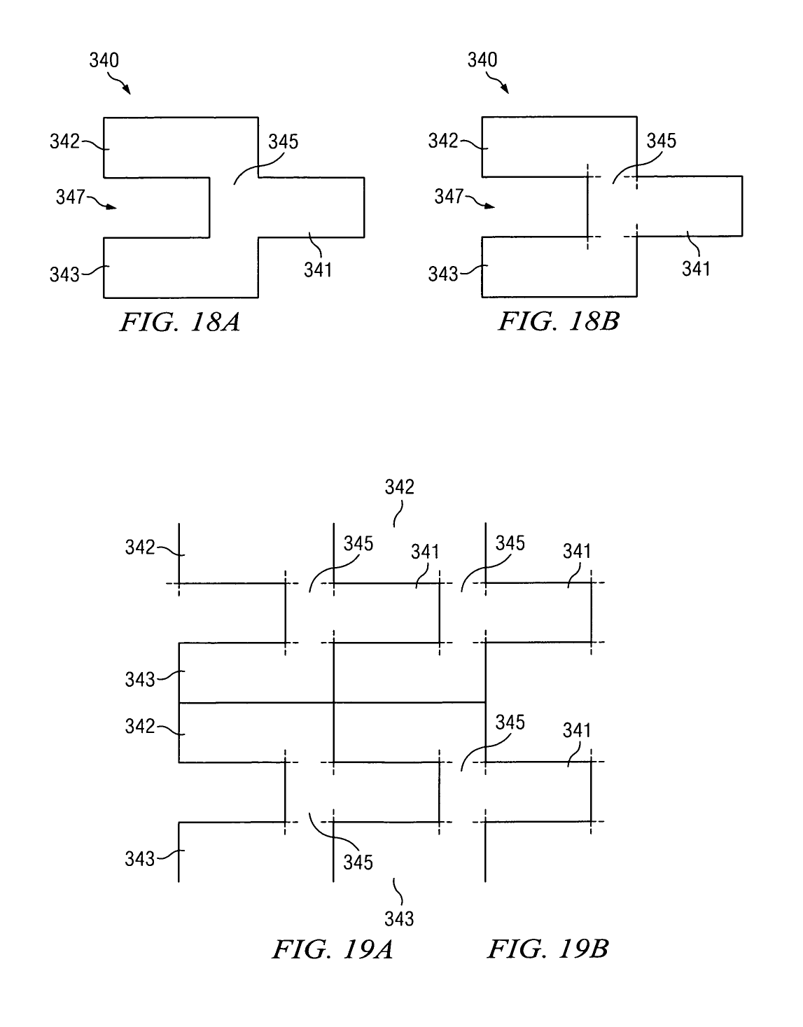

Referring to FIG. 17A, the saw tooth horizontal cutting blade configuration 332 on the exterior of cutting roller 320 is shown. FIG. 17B shows the lateral straight-line cutting blade configuration on the exterior of cutting roller 330. As can be seen, each individual cutting element 322 is identical to the other cutting elements 322. Likewise, each individual cutting element 332 is identical to the other cutting elements 332. An individual workpiece is cut after passing along both cutting element 322 and then across cutting element 332. Cutting element 332 lies perpendicular to axle 335, while cutting element 322 has a singular upper portion and two lower leg portions and extend the length of cutting roller 320. Cutting element 322 is generally parallel to axle 325. The workpieces cut from the cutting materials by the cutting rollers 320 and 330 will possess this same shape including an upper portion and two lower portions. This preferred shape is best seen in FIG. 18A-19B.

A void fill packing material 340 embodying the material cut by the present invention is disclosed in FIG. 18A-19B. Void fill material 340 is comprised of a primary section 345 and, in a preferred embodiment, three appendages or “fingers” 341, 342, 343. Typically, a first finger 341 is attached to one side of primary section 345, while a second and third finger 342, 343 are located on the opposite side of primary section 345. The intersection of each finger 341, 342, 343 with primary section 345 can be scored to allow for bending of each finger away from the plane defined by primary section 345.

In a preferred embodiment, as illustrated in FIG. 18A, the first finger 341 can be (0.75) ¾ inch in length and (0.4375) 7/16 inch in width. The second and third fingers 342, 343 can be (0.75) ¾ inch in length by (0.4375) 7/16 inch in width. The primary section 345 can be (1.3125) 21/16 inch in length and 0.3745 inch in width. The second and third fingers 342, 343 are separated by a distance of (0.4375) 7/16 inch. This, the first finger 341 of one piece of the void fill packing material 340 can engage the area between the second and third fingers 342, 343 of an adjacent piece of void fill packing material. Of course, the dimensions provided describe only one embodiment of the invention, and can be altered to suit an individual's needs.

FIG. 18B further illustrates the maximum overcut that can be made to allow the void fill packing material 340 to function properly. The maximum overcut that can be made to the widths of primary section 345 or fingers 341, 342, or 343 is 3/32 inch.

FIG. 19 further illustrates the maximum undercut that can be made to allow the void fill packing material 340 to function properly. The maximum undercut that can be made to the widths of primary section 345 or fingers 341, 342, or 343 is 3/32 inch.

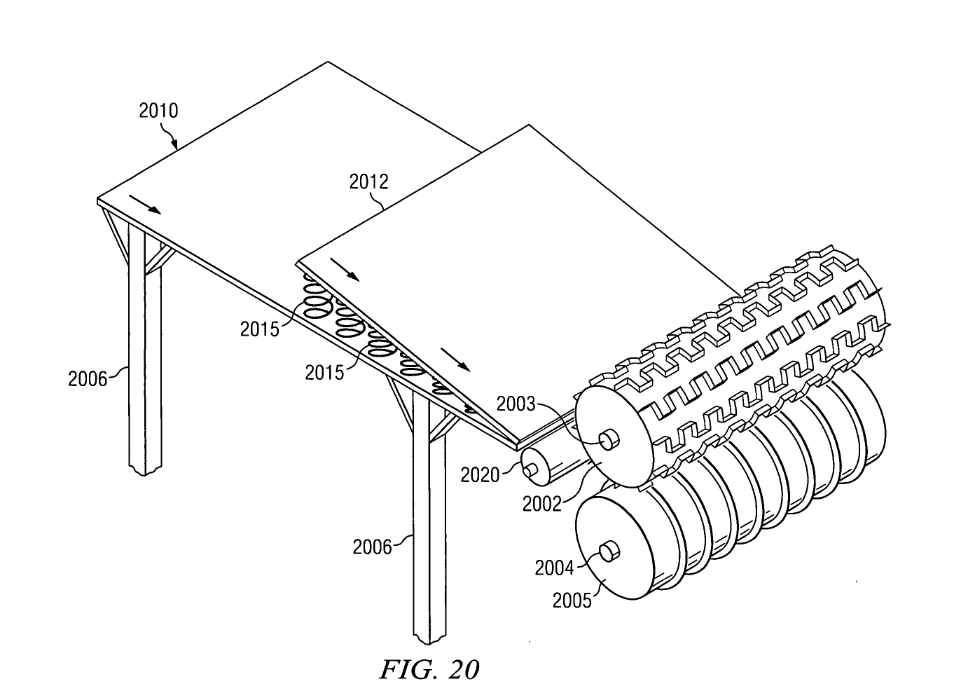

FIG. 20 shows a table guide assembly 2010 where raw cutting material is supported and fed into the cutting mechanism. The table guide 2010 is supported by table legs 2006, and the cutting material 2012 is placed on the table assembly 2010 and passes over the guide roller 2020 before being cut between the cutting and anvil rollers 2002 and 2005 respectively. The rollers 2002 and 2005 rotate around the axles 2003 and 2004, respectively. The table guide assembly 2010 provides support for the cutting material 2012 and allows that material 2012 to flatten out before being cut between the cutting and anvil rollers 2002 and 2005.

While the invention has been particularly shown and described with respect to preferred embodiments, it will be readily understood that minor changes in the details of the invention may be made without departing from the spirit of the invention. Having described the invention, I claim:

1. A system for cutting void fill material comprising:
at least one first cutting cylinder having horizontal cutting blades positioned adjacent to at least one first anvil cylinder, where cutting material is cut when it passes between the horizontal cutting cylinder and the adjacent anvil cylinder, said horizontal cutting blades making the initial cuts for a void fill material having at least two elongated members extending from a central body member; and
at least one second cutting cylinder having vertical cutting blades positioned adjacent to at least one second anvil cylinder where cutting material exiting first cylinder and first anvil is cut further when it passes between the vertical cutting blades on the second cutting cylinder and the second anvil cylinder, said vertical cutting blades making a second cut for void fill material having at least two elongated members extending from a central body member, said elongated members form separated void fill pieces intended to interlock around or on packaged product during delivery and transit of the packaged product.

2. The system of claim 1 wherein one or more of the cutting cylinders is pressurized with air to eject cut pieces from between the cutting blades.

3. The system of claim 1 wherein a pair of guide rollers is center-mounted between the first and second cutting rollers.

4. The system of claim 3 wherein at least one additional guide roller is positioned on one side of the first or second cutting rollers.

5. The system of claim 3 wherein at least one additional static guide is positioned on one side of the first or second cutting rollers.

6. The system of claim 1 wherein a table guide assembly supports the cutting material before it passes between the first cutting cylinder and the first anvil cylinder.

7. The system of claim 6 wherein a pair of guide rollers is center-mounted between the first and second cutting rollers.

8. The system of claim 7 wherein at least one additional guide rollers is positioned on one side of the first or second cutting rollers.

9. The system of claim 7 wherein at least one additional static guide is positioned on one side of the first or second cutting rollers.

10. A system for cutting void fill material comprising:
at least one first cutting cylinder having horizontal cutting blades positioned adjacent to at least one first anvil cylinder, where cutting material is cut when it passes between the horizontal cutting cylinder and the adjacent anvil cylinder, said horizontal cutting blades making the initial cuts for a void fill material having at least two elongated members extending from a central body member;
a first drive mechanism associated with the first cutting cylinder to mechanically drive the first horizontal cutting cylinder;
at least one second cutting cylinder having vertical cutting blades positioned adjacent to at least one second anvil cylinder where cutting material exiting first cylinder and first anvil is cut further when it passes between the vertical cutting blades on the second cutting cylinder and the second anvil cylinder, said vertical cutting blades making a second cut for void fill material having at least two elongated members extending from a central body member, said elongated members form separated void fill pieces intended to interlock around or on packaged product during delivery and transit of the packaged product; and,
a second drive mechanism associated with the second cutting cylinder to mechanically drive the second vertical cutting cylinder.

11. The system of claim 10 wherein one or more of the cutting cylinders is pressurized with air to eject cut pieces from between the cutting blades.

12. The system of claim 10 wherein a pair of guide rollers is center-mounted between the first and second cutting rollers.

13. The system of claim 12 wherein at least one additional guide roller is positioned on one side of the first or second cutting rollers.

14. The system of claim 12 wherein at least one additional static guide is positioned on one side of the first or second cutting rollers.

15. The system of claim 10 wherein a table guide assembly supports the cutting material before it passes between the first cutting cylinder and the first anvil cylinder.

16. The system of claim 10 wherein a pair of guide rollers is center-mounted between the first and second cutting rollers.

17. The system of claim 16 wherein at least one additional guide rollers is positioned on one side of the first or second cutting rollers.

18. The system of claim 16 wherein at least one additional static guide is positioned on one side of the first or second cutting rollers.

19. A method for cutting void fill material comprising the steps of:
preparing a substantially flattened piece of cutting material;
engaging said cutting material with at least one first cutting cylinder having horizontal cutting blades positioned adjacent to at least one first anvil cylinder, where cutting material is cut when it passes between the horizontal cutting cylinder and the adjacent anvil cylinder, said horizontal cutting blades making the initial cuts for a void fill material having at least two elongated members extending from a central body member;
engaging said cutting material with at least one second cutting cylinder having vertical cutting blades positioned adjacent to at least one second anvil cylinder where cutting material exiting first cylinder and first anvil is cut further when it passes between the vertical cutting blades on the second cutting cylinder and the second anvil cylinder, said vertical cutting blades making a second cut for void fill material having at least two elongated members extending from a central body member, said elongated members form separated void fill pieces intended to interlock around or on packaged product during delivery and transit of the packaged product; and
driving at least one of said first or second cutting cylinders with at least one drive mechanism associated with the first or second cutting cylinder, wherein driving the cylinder makes the cylinder engage the cutting material.
a second drive mechanism associated with the second cutting cylinder.

20. The method of claim 19 comprising of one or more of the cutting cylinders is pressurized with air to eject cut pieces from between the cutting blades.

21. The method of claim 19 comprising of a pair of guide rollers is center-mounted between the first and second cutting rollers.

22. The method of claim 21 comprising of at least one additional guide roller is positioned on one side of the first or second cutting rollers.

23. The method of claim 21 comprising of at least one additional static guide is positioned on one side of the first or second cutting rollers.

24. The method of claim 19 comprising of a table guide assembly supports the cutting material before it passes between the first cutting cylinder and the first anvil cylinder.

25. The method of claim 19 comprising of a pair of guide rollers is center-mounted between the first and second cutting rollers.

26. The method of claim 19 comprising of at least one additional guide rollers is positioned on one side of the first or second cutting rollers.

27. The method of claim 16 comprising of at least one additional static guide is positioned on one side of the first or second cutting rollers.
